(19) United States
(12) Patent Application Publication
(10) Pub. No.: US 2017/0147476 A1
(43) Pub. Date: May 25, 2017

(54) METHOD AND APPARATUS FOR INTEGRATION OF SOFTWARE DEVELOPMENT

(71) Applicants: Le Holdings (Beijing) Co., Ltd., Beijing (CN); LeCloud Computing Co., Ltd., Beijing (CN)

(72) Inventor: Gaofeng JI, Beijing (CN)

(21) Appl. No.: 15/245,299

(22) Filed: Aug. 24, 2016

Related U.S. Application Data
(63) Continuation of application No. PCT/CN2016/082822, filed on May 20, 2016.

(30) Foreign Application Priority Data
Nov. 20, 2015 (CN) 201510812181.2

(51) Int. Cl. G06F 11/36; G06F 17/30; G06F 9/45

(52) U.S. Cl. CPC G06F 11/3664; G06F 8/41; G06F 17/30979

(57) ABSTRACT

Disclosed are a method and an apparatus for integration of software development. The method includes: acquiring basic information of a source code, wherein the basic information comprises an address of the source code and a language type of the source code; searching for the source code via the address of the source code; deploying a compiling environment and a testing environment according to the language type, wherein the compiling environment and the testing environment are environments respectively suitable for the language type of the source code; loading the source code to the compiling environment for compiling to obtain a code data packet; loading the code data packet to the testing environment for testing; and publishing the code data packet on line if the code data packet passed the testing.

### CROSS-REFERENCE TO RELATED APPLICATIONS

This application is a continuation of International Application No. PCT/CN2016/082822, with an international filing date of May 20, 2016, which is based upon and claims priority to Chinese Patent Application No. 201510812181.2, filed on Nov. 20, 2015, the entire contents of which are incorporated herein by reference.

### TECHNICAL FIELD

The present disclosure relates to the field of internet technologies, and more particularly, to a method and apparatus for integration of software development.

### BACKGROUND

Software development is a process of building a software system or software parts in the system according to a user's requirements. A software development process generally relates to several steps of source code development, compiling, testing and publishing on line, etc.

In the prior art, steps of compiling, testing and publishing on line in the software development process are carried out independently. Specifically, running environments of these need to be manually deployed. For example, the step of compiling needs different compiling environments deployed manually according to a language type of a source code; and in the step of testing, a test technician needs to deploy a test system version, a language type and a specific testing example according to characteristics of the source code. In the foregoing software development process, it is found that it is time-consuming and error-prone by way of manually deploying the running environments of various steps. It can be known from above that the existing software development process is low in efficiency.

### SUMMARY

The present disclosure provides a method and apparatus for integration of software development to solve a problem of low efficiency in the existing software development process.

In a first aspect, embodiments of the present disclosure provide a method for integration of software development, implemented by an electronic device, including:

acquiring basic information of a source code, where the basic information includes an address of the source code and a language type of the source code;

searching for the source code via the address of the source code;

deploying a compiling environment and a testing environment according to the language type, where the compiling environment and the testing environment are environments respectively suitable for the language type of the source code;

loading the source code to the compiling environment for compiling and obtaining a code data packet;

loading the code data packet to the testing environment for testing; and

publishing the code data packet on line if the code data packet passed the testing.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for integration of software development mentioned by embodiments of the present disclosure.

In a third aspect, embodiments of the present disclosure provide a non-transitory computer-readable storage medium storing executable instructions that, when executed by an electronic device, cause the electronic device to perform any methods for integration of software development mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for integration of software development in accordance with some embodiments;

FIG. 2 is a flowchart of another method for integration of software development in accordance with some embodiments;

FIG. 3 is a block diagram showing composition of an apparatus for integration of software development in accordance with some embodiments;

FIG. 4 is a block diagram showing composition of another apparatus for integration of software development in accordance with some embodiments; and

FIG. 5 is a block diagram showing composition of an electronic device in accordance with some embodiments.

### DETAILED DESCRIPTION

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure.

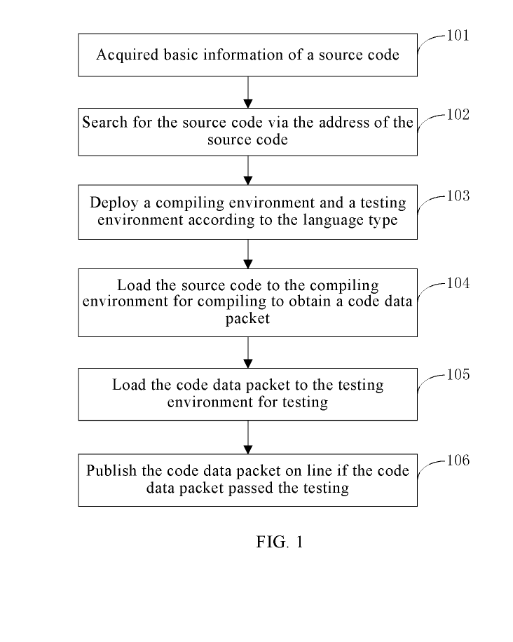

An embodiment of the present disclosure provides a method for integration of software development, as shown in FIG. 1, the method includes:

101: Acquiring basic information of a source code.

The basic information of the source code is set up and maintained by outside. The basic information of the source code includes an address of the source code, a language type of the source code, and a system to which the source code belongs. The address refers to the address in which the source code is stored; the language type refers to a computer language type used for editing the source code, including various high-level computer programming languages such as C, C++, java and so on; and the system to which the source code belongs is divided into three types, respectively a core system, a business support system and a peripheral system, and different systems have different levels.

102: Searching for the source code via the address of the source code.

The address of the source code is looked up from the basic information in Step 101, and then the source code is acquired according to the address in which the source code is stored.

103: Deploying a compiling environment and a testing environment according to the language type.

After the source code is acquired, the source code needs to be compiled and tested. The compiling environment and the testing environment are deployed before the source code is compiled and tested. Compiling environments and testing environments suitable for source codes of different language types are different. Therefore, a compiling environment and a testing environment suitable for a source code need to be deployed according to the language type of the source code. In this embodiment, compiling environments and testing environments suitable for various language types can be deployed. Therefore, a source code of any language type may be compiled and tested in the following.

104: Loading the source code to the compiling environment for compiling to obtain a code data packet.

The source code can be compiled after the suitable compiling environment is deployed. Compiling refers to converting a high-level computer language used in the source code to a computer-recognizable binary language. Specifically, the source code acquired in Step 102 is loaded to the compiling environment suitable for the source code obtained in Step 103 for compiling. A compiling process mainly includes: lexical analysis, grammatical analysis, semantic check and intermediate code generation, code optimization, and target code generation. Compiling mainly includes analyzing a source code by means of a compiling program and generating a target code. The compiling program is designed by a programmer in advance and can be directly invoked when in use; and the generated target code is the code data packet in this embodiment.

105: Loading the code data packet to the testing environment for testing.

The code data packet obtained in Step 104 is loaded to the testing environment obtained in Step 103 for testing. The testing in this example is an automated testing process. An automated testing is dependent on a set of programs that can implement the automated testing, and automated testing programs are edited by technical personnel in advance. The automated testing programs can be reused.

106: Publishing the code data packet on line if the code data packet passed the testing.

Publishing on line refers that the code data packet that passed the testing is deployed to an actual computer system. Therefore, it is a precondition of publishing on line for the code data packet to pass the testing. It is to be noted that passing the testing does not signify that no problem of abnormal operation will occur after the publishing on line. Therefore, in the process of publishing a code on line, it is necessary to monitor in real time running conditions of all practical computer systems, so as to ensure that abnormality is found timely in the process of publishing a code data packet on line and is timely notified to outside.

Further, for different source codes, certain steps in FIG. 1 can be selected and carried out according to system levels to which the source codes belong. The core system belongs to a level-0 system, the business support system belongs to a level-1 system, and the peripheral system belongs to a level-2 system, all steps in FIG. 1 are required for the level-0 system and the level-1 system, and the link of publishing on line can be required for the level-2 system.

The method for integration of software development provided by an embodiment of the present disclosure can automatically acquire a source code by means of basic information of the source code set up by outside, deploy a compiling environment and a testing environment according to a language type in the basic information of the source code, load the source code to the compiling environment for compiling to obtain a code data packet, then load the code data packet to the testing environment for testing, and finally publish the code on line if the code passed the testing. Compared with the prior art, the embodiment of the present disclosure can integrate compiling, testing and publishing steps in the process of software development to a system platform, and each of the steps is automatically implemented without manual deployment of a running environment of each step, which can save time and reduce probability of error occurrence, thereby improving software development efficiency.

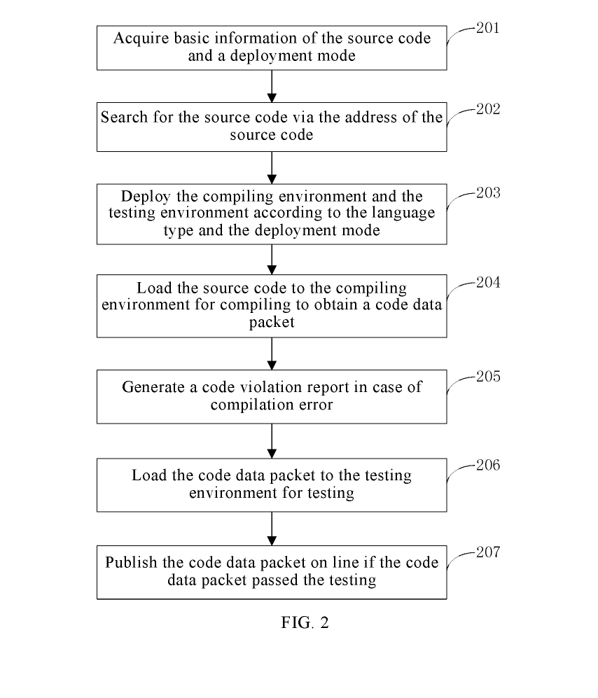

Further, as refinement and extension of the embodiment as shown in FIG. 1, the present disclosure further provides another embodiment. As shown in FIG. 2, the method for integration of software development in this embodiment includes:

201: Acquiring basic information of the source code and a deployment mode.

Acquiring a deployment mode refers to acquiring a deployment mode selected by outside. The deployment mode in this embodiment is classified according to a carrier of code running, including Tomcat, Apache and so on. Different deployment modes may be selected by outside. The deployment mode is related to the subsequent deployment testing environment.

In addition, an implementation manner for acquiring the basic information of the source code in this step is the same as the implementation manner of Step 101 in FIG. 1, which is not unnecessarily described herein.

202: Searching for the source code via the address of the source code.

An implementation mode of this step is the same as that of Step 102 in FIG. 1, and thus is not unnecessarily described herein.

203: Deploying the compiling environment and the testing environment according to the language type and the deployment mode.

The compiling environment is related to the language type. Therefore a suitable compiling environment needs to be selected according to the language type of the source code.

The testing environment not only is related to the language type but also is related to the selected deployment mode. If the deployment mode is selected by outside, the testing environment needs to be deployed according to the selected deployment mode; if there is no selection of deployment modes, any deployment mode can be provided to deploy the testing environment. In a general case, any deployment mode may be suitable for all source codes.

204: Loading the source code to the compiling environment for compiling to obtain a code data packet.

An implementation mode of this step is the same as that of Step 104 in FIG. 1, and thus is not unnecessarily described herein.

205: Generating a code violation report in case of compilation error.

In the process of compiling in Step 204, a compilation error occurred includes code error, no note, and no testing example, etc. The compilation error is judged by means of a code review rule, and all compilation errors are recorded to generate a code violation report. A place where the compilation error occurs and a type to which the compilation error belongs are recorded in detail in the code violation report.

206: Loading the code data packet to the testing environment for testing.

An implementation mode of this step is the same as that of Step 105 in FIG. 1, and thus is not unnecessarily described herein.

207: Publishing the code data packet on line if the code data packet passed the testing.

Manners for publishing the code data packet that passed the testing on line include two manners as below:

Manner I

Publishing at one time. Publishing at one time refers that the code data packet that passes the testing is published onto all computer systems at one time.

Manner II

Gray-scale publication. Gray-scale publication refers that the code data packet is published in batches, namely the code data packet is published to a part of computer systems, and then a scope of publication is gradually extended until the code data packet is published to all the computer systems. Specifically, when it is implemented to publish the code data packet in batches, all the computer systems can be divided into different groups, and then the code data packet is published in groups step by step. Grouping may be implemented according to Internet Protocol (abbreviated to IP) Address or to different machine rooms where users are.

Implementation of gray-scale distribution is specifically described by grouping according to different machine rooms where the computer systems are. Supposing users are grouped as three machine rooms, a specific implementation process is as below: the code data packet that passed the testing is first published to computer systems in No. 1 machine room, and running conditions of the computer systems are monitored in real time; if the computer systems in No. 1 machine room can meet anticipated running requirements, the code data packet is published to computer systems in No. 2 machine room, then the computer systems in No. 1 machine room and No. 2 machine room are simultaneously monitored in real time; if all the computer systems in No. 1 machine room and No. 2 machine room meet anticipated running requirements, the code data packet is published to computer systems in No. 3 machine room, and simultaneously running conditions of the computer systems in No. 3 machine room also need to be monitored in real time.

It is to be noted that when the code data packet is divided into some parts for publishing, a time interval for publishing each part can be artificially controlled, and each time interval can be different.

Further, in this embodiment, a shared communication interface is provided for outside, and the shared communication interface integrates cloud sharing and real-time chatting tools to implement communications among outsides and sharing of the source code.

The cloud sharing is implemented by using a github source code management tool, where each person can establish a codebase of his/her own, a source code edited by himself/herself is uploaded to the codebase, then the codebase is shared by means of github, employee s from a same company or department can view codebases of all other employees, carry out secondary development on a basis of codes in codebases of other employees, and then update to the codebase of his/her own.

In addition, the added real-time chatting tools are used for implementing exchanging among employees, mainly regarding comment and communications on source codes of codebases.

Further, this embodiment also provides a function of code integration, namely, when a source code is modified by outside, code integration of the source code is automatically finished, and the integrated code is automatically compiled. A code violation report can also be generated if an error is found in the compilation process. A complete process of software compiling, testing and publishing of the integrated codes needs to be carried out according to the complete procedure in FIG. 1 or FIG. 2.

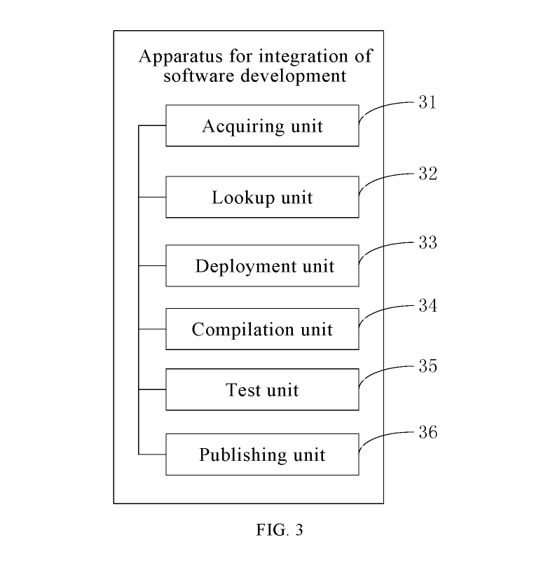

Further, as implementation of the method as shown in the foregoing FIG. 1 or FIG. 2, another embodiment of the embodiments of the present disclosure further provides an apparatus for integration of software development, as shown in FIG. 3, the apparatus includes: an acquiring unit 31, a lookup unit 32, a deployment unit 33, a compilation unit 34, a test unit 35 and a publishing unit 36.

The acquiring unit 31 is configured to acquire basic information of a source code, where the basic information includes an address of the source code and a language type of the source code.

In addition, the basic information of the source code acquired by the acquiring unit further includes a system to which the source code belongs. The address in the basic information refers to the address in which the source code is stored; the language type refers to a computer language type used for editing the source code, including various high-level computer programming languages; and the system to which the source code belongs is divided into three types, respectively a core system, a business support system and a peripheral system, and different systems have different levels.

The lookup unit 32 is configured to search for the source code via the address of the source code.

The address of the source code is looked up from the basic information acquired by the acquiring unit, and then the source code is acquired according to the address in which the source code is stored.

The deployment unit 33 is configured to deploy a compiling environment and a testing environment according to the language type, where the compiling environment and the testing environment are environments respectively suitable for the language type of the source code.

After the source code is acquired, the source code needs to be compiled and tested. The compiling environment and the testing environment are deployed before the source code is compiled and tested. Compiling environments and testing environments suitable for source codes of different language types are different. Therefore, a compiling environment and a testing environment suitable for a source code need to be deployed according to the language type of the source code. In this embodiment, compiling environments and testing environments suitable for various language types may be deployed. Therefore, a source code of any language type may be compiled and tested in the following.

The compilation unit 34 is configured to load the source code to the compiling environment for compiling to obtain a code data packet.

Specifically, the source code acquired by the acquiring unit is loaded to the compiling environment deployed by the deployment unit for compiling. A compiling process mainly includes: lexical analysis, grammatical analysis, semantic check and intermediate code generation, code optimization, and target code generation. Compiling mainly includes analyzing a source code by means of a compiling program and generating a target code. The generated target code is the code data packet in this embodiment.

The test unit 35 is configured to load the code data packet to the testing environment for testing.

The code data packet obtained by the compilation unit is loaded to the testing environment deployed by the deployment unit for testing. The testing in this example is an automated testing process. An automated testing is dependent on a set of programs that can implement the automated testing, and automated testing programs are edited by technical personnel in advance. The automated testing programs can be reused.

The publishing unit 36 is configured to publish the code data packet that passed the testing on line.

In this embodiment, manners for publishing the code data packet that passes the testing on line include two manners as below: publishing at one time and gray-scale publication respectively. Publishing at one time refers that the code data packet that passes the testing is published onto all computer systems at one time. Gray-scale publication refers that the code data packet is published in batches, namely the code data packet is published to a part of computer systems, and then a scope of publication is gradually extended until the code data packet is published to all the computer systems. Specifically, when it is implemented to publish the code data packet in batches, all the computer systems can be divided into different groups, and then the code data packet is published in groups step by step. Grouping may be implemented according to IP Address or to different machine rooms where the computer systems are.

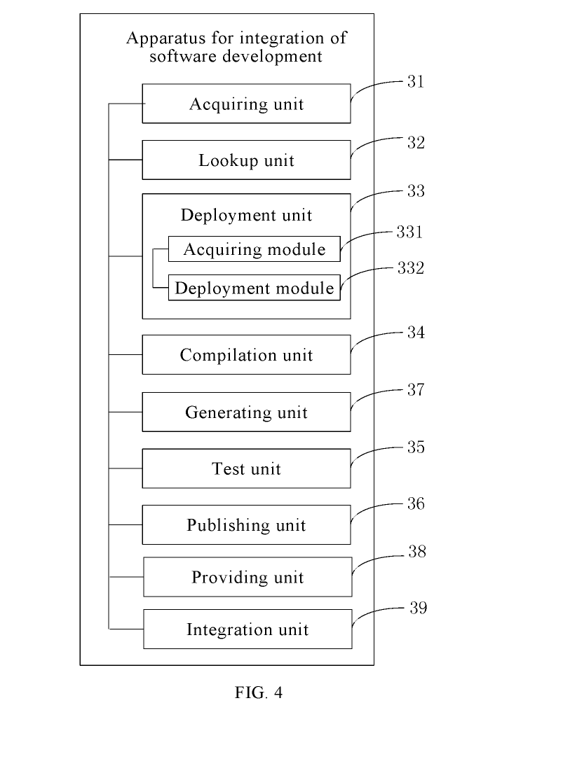

Further, as shown in FIG. 4, the apparatus further includes:

a generating unit 37, configured to generate a code violation report in case of compilation error after obtaining the code data packet, where the code violation report is used for recording a code error message detected during compilation.

In the compilation process, a compilation error occurred includes code error, no note, and no testing example, etc. The compilation error is judged by means of a code review rule, and all compilation errors are recorded to generate a code violation report. A place where the compilation error occurs and a type to which the compilation error belongs are recorded in detail in the code violation report.

Further, as shown in FIG. 4, the deployment unit 33 includes:

an acquiring module 331, configured to acquire a deployment mode, where the deployment mode is a deployment mode selected by outside.

Acquiring a deployment mode refers to acquiring a deployment mode selected by outside. The deployment mode in this embodiment is classified according to a carrier of code running, including a Tomcat server, and an Apache server, etc. Different deployment modes can be selected by outside. The deployment mode is related to the subsequent deployment testing environment.

A deployment module 332, configured to deploy the testing environment according to the deployment mode and the language type.

The compiling environment is related to the language type. Therefore a suitable compiling environment needs to be selected according to the language type of the source code.

The testing environment not only is related to the language type but also is related to the selected deployment mode. If the deployment mode is selected by outside, the testing environment needs to be deployed according to the selected deployment mode; if there is no selection of deployment modes, any deployment mode may be provided to deploy the testing environment. In a general case, any deployment mode can be suitable for all source codes.

Further, as shown in FIG. 4, the apparatus further includes:

a providing unit 38, configured to provide a shared communication interface, where the shared communication interface is configured to implement communications among outsides and sharing of source codes.

The shared communication interface integrates cloud sharing and real-time chatting tools to implement communications among outsides and sharing of source codes.

The cloud sharing is implemented by using a github source code management tool, where each person can establish a codebase of his/her own, upload a source code edited by himself/herself to the codebase of his/her own, then share the codebase by means of github, or carry out secondary development on a basis of codes in other codebases, and then update to the codebase of his/her own.

In addition, the added real-time chatting tools are used for implementing communications among employees, mainly regarding comment and communications on source codes in codebases.

Further, as shown in FIG. 4, the apparatus further includes:

an integration unit 39, configured to perform code integration on a source code if the source code is modified by outside.

Code integration of the source code is automatically finished when the source code is modified by outside, and the integrated code is compiled. A code violation report may also be generated if an error is found in the compilation process.

The apparatus for integration of software development provided by the embodiment of the present disclosure can automatically acquire a source code by means of basic information of the source code set up by outside, deploy a compiling environment and a testing environment according to a language type in the basic information of the source code, load the source code to the compiling environment for compiling to obtain a code data packet, then load the code data packet to the testing environment for testing, and finally publish the code on line if the code passes the testing. Compared with the prior art, the embodiments of the present disclosure can integrate compiling, testing and publishing steps in the process of software development to a system platform, and each of the steps is automatically implemented without artificial deployment of a running environment of each step, which can save time and reduce probability of error occurrence, thereby improving software development efficiency.

Further, an embodiment of the present disclosure further provides a non-transitory computer-readable storage medium storing executable instructions, which can be executed by an electronic device to perform any methods for integration of software development mentioned by embodiments of the present disclosure.

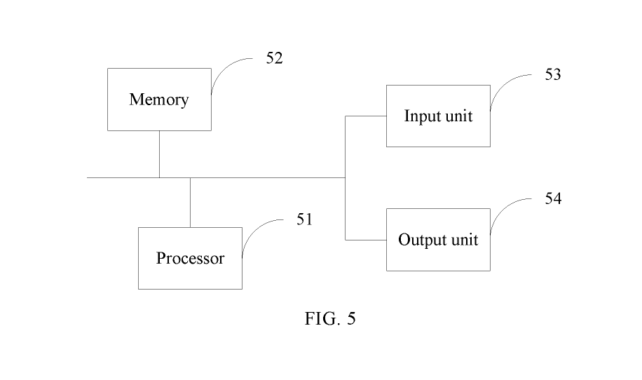

FIG. 5 is a block diagram of an electronic device which is configured to perform the methods for integration of software development according to an embodiment of the present disclosure. As shown in FIG. 5, the device includes: one or more processors 51 and memory 52. A processor 51 is showed in FIG. 5 for an example.

Device which is configured to perform the methods for integration of software development can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for integration of software development mentioned by embodiments of the present disclosure (such as shown in FIG. 3, acquiring unit 31, lookup unit 32, deployment unit 33, compilation unit 34, test unit 35, publishing unit 36). Processor 51 performs kinds of functions and data processing of the electronic device by executing non-transitory software program, instructions and modules which are stored in memory 52, thereby realizes the methods for integration of software development mentioned by embodiments of the present disclosure.

Memory 52 can include program storage area and data storage area, thereby the operating system and applications required by at least one function can be stored in program storage area and data created by using the device for integration of software development can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for integration of software development by networks. The examples of said networks are including but not limited to Internet, Intranet, LAN, mobile Internet and their combinations.

Input unit 53 can be used to receive inputted number, character information and key signals causing user configures and function controls of the device for integration of software development. Output unit 54 can include a display screen or a display device.

The said module or modules are stored in memory 52 and perform the methods for integration of software development when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The apparatus embodiment set forth above is merely exemplary, where units described as detached parts can be or not be detachable physically; parts displayed as units can be or not be physical units, i.e., either located at the same place, or distributed on a plurality of network units. Modules may be selected in part or in whole according to actual needs for achieving objectives of the solution of this embodiment.

It can be known from the foregoing implementation modes, those skilled in the art may clearly know that various implementation modes can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (a personal computer, or a server, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for integration of software development, implemented by an electronic device, comprising:
acquiring basic information of a source code, wherein the basic information comprises an address of the source code and a language type of the source code;
searching for the source code via the address of the source code;
deploying a compiling environment and a testing environment according to the language type, where the compiling environment and the testing environment are environments respectively suitable for the language type of the source code;
loading the source code to the compiling environment for compiling to obtain a code data packet;
loading the code data packet to the testing environment for testing; and
publishing the code data packet on line if the code data packet passed the testing.

2. The method according to claim 1, wherein after the obtaining a code data packet, the method further comprises:
generating a code violation report in case of compilation error, wherein the code violation report is used for recording a code error message detected during compilation.

3. The method according to claim 1, wherein the deploying a testing environment according to the language type comprises:
acquiring a deployment mode, wherein the deployment mode is a deployment mode selected by outside; and
deploying the testing environment according to the deployment mode and the language type.

4. The method according to claim 1, further comprising:
providing a shared communication interface configured to implement communications among outsides and sharing of the source code.

5. The method according to claim 1, further comprising:
performing code integration on the source code if the source code is modified by outside.

6. An electronic device, comprising:
at least one processor; and
a memory communicably connected with the at least one processor for storing instructions executable by the at least one processor,
wherein execution of the instructions by the at least one processor causes the at least one processor to:
acquire basic information of a source code, wherein the basic information comprises an address of the source code and a language type of the source code;
search for the source code via the address of the source code;
deploy a compiling environment and a testing environment according to the language type, wherein the compiling environment and the testing environment are environments respectively suitable for the language type of the source code;
load the source code to the compiling environment for compiling to obtain a code data packet;
load the code data packet to the testing environment for testing; and
publish the code data packet on line if the code data packet passed the testing.

7. The electronic device according to claim 6, wherein after obtaining a code data packet, the instructions are executed to cause the at least one processor to:
generate a code violation report in case of compilation error, wherein the code violation report is used for recording a code error message detected during compilation.

8. The electronic device according to claim 6, wherein deploying a testing environment according to the language type comprises:
acquiring a deployment mode, wherein the deployment mode is a deployment mode selected by outside; and
deploying the testing environment according to the deployment mode and the language type.

9. The electronic device according to claim 6, wherein the instructions are executed to cause the at least one processor to:
provide a shared communication interface configured to implement communications among outsides and sharing of the source code.

10. The electronic device according to claim 6, wherein the instructions are executed to cause the at least one processor to:
perform code integration on the source code if the source code is modified by outside.

11. A non-transitory computer-readable storage medium storing executable instructions that, when executed by an electronic device, cause the electronic device to:
acquire basic information of a source code, wherein the basic information comprises an address of the source code and a language type of the source code;
search for the source code via the address of the source code;
deploy a compiling environment and a testing environment according to the language type, wherein the compiling environment and the testing environment are environments respectively suitable for the language type of the source code;
load the source code to the compiling environment for compiling to obtain a code data packet;
load the code data packet to the testing environment for testing; and
publish the code data packet on line if the code data packet passed the testing.

12. The non-transitory computer-readable storage medium according to claim 11, wherein after obtaining a code data packet, the executable instructions are executed to cause the electronic device to:
generate a code violation report in case of compilation error, wherein the code violation report is used for recording a code error message detected during compilation.

13. The non-transitory computer-readable storage medium according to claim 11, wherein deploying a testing environment according to the language type comprises:
acquiring a deployment mode, wherein the deployment mode is a deployment mode selected by outside; and
deploying the testing environment according to the deployment mode and the language type.

14. The non-transitory computer-readable storage medium according to claim 11, wherein the executable instructions are executed to cause the electronic device to:
provide a shared communication interface configured to implement communications among outsides and sharing of the source code.

15. The non-transitory computer-readable storage medium according to claim 11, wherein the executable instructions are executed to cause the electronic device to:
perform code integration on the source code if the source code is modified by outside.
